(19) United States
(12) Patent Application Publication
(10) Pub. No.: US 2026/0287447 A1
(43) Pub. Date: Sep. 24, 2026

(54) HIGH TEMPERATURE PRESSURE SENSOR MODULE

(71) Applicant: BAE Systems Information and Electronic Systems Integration Inc., Nashua, NH (US)

(72) Inventors: Amrita V. Masurkar, Burlington, MA (US); Renyuan Wang, Windham, NH (US); Matthew Conte, Woburn, MA (US); Jonathan P. Comeau, Winchester, MA (US)

(73) Assignee: BAE Systems Information and Electronic Systems Integration Inc., Nashua, NH (US)

(21) Appl. No.: 19/083,673

(22) Filed: Mar. 19, 2025

(51) Int. Cl. G01L 1/16

(52) U.S. Cl. CPC G01L 1/16

(57) ABSTRACT

High temperature pressure sensor module. A carrier comprising a piezoelectric material comprising a chemical compound including lanthanum and gallium. A signal conditioning circuit die disposed on the carrier, the signal conditioning circuit die comprising: a silicon carbide substrate, and transistors disposed on the substrate. A pressure transducer die disposed on the carrier, adjacent to the signal conditioning die, and comprising: a membrane comprising the chemical compound, a plurality of metal contacts disposed on a first side of the membrane, a first cavity etched into a second side of the membrane and configured as a first side of a first piezoelectric pressure transducer, and a second cavity etched into the second side of the membrane and configured as a first side of a second piezoelectric pressure transducer. The carrier is bonded to the second side of the membrane such that the carrier forms a second side to the piezoelectric pressure transducers.

### FIELD OF DISCLOSURE

The present disclosure relates to pressure sensors, and more particularly to a high temperature pressure sensor module.

### BACKGROUND

Pressure sensors are devices configured to measure pressure applied to the sensor and have many uses in the industrial, automotive, medical, environmental, aerospace, and military arenas. Existing pressure sensors are typically limited, however, to operation in relatively low temperature environments, for example at less than 250 degrees Celsius (C.). Some applications, such as aerospace and military applications, can present more challenging operating environments in which existing pressure sensors may not operate properly or have limited life.

### BRIEF DESCRIPTION OF THE DRAWINGS

FIG. 1 illustrates a pressure sensor module, configured in accordance with certain embodiments of the present disclosure.

FIG. 2A is a block diagram of the signal conditioning circuit of FIG. 1, configured in accordance with certain embodiments of the present disclosure.

FIG. 2B is a schematic circuit diagram of the amplifiers of FIG. 2A, configured in accordance with certain embodiments of the present disclosure.

FIG. 3 is a perspective view of the structure of an example multi-channel transistor of FIG. 2B, configured in accordance with certain embodiments of the present disclosure.

FIG. 4A is a cross-sectional and perspective view of the gate and channel of FIG. 3, configured in accordance with certain embodiments of the present disclosure.

FIG. 4B is a cross-sectional view of one channel of the multi-channel transistor of FIG. 4A, configured in accordance with certain embodiments of the present disclosure.

FIGS. 5A-5D illustrate cross-sectional and top-down views that collectively illustrate an example process for forming the transistors of FIG. 3, in accordance with an embodiment of the present disclosure.

FIG. 6 illustrates cross-sectional views that collectively illustrate an example process for forming the pressure transducer die of FIG. 1, in accordance with certain embodiments of the present disclosure.

FIG. 7 illustrates cross-sectional views that collectively illustrate an example process for forming the pressure sensor module of FIG. 1, in accordance with certain embodiments of the present disclosure.

FIG. 8 shows a method of forming an integrated circuit structure including a transistor, in accordance with one or more embodiments of the present disclosure.

FIG. 9 shows a method of forming a transducer die, in accordance with one or more embodiments of the present disclosure.

FIG. 10 shows a method of forming a pressure sensor module, in accordance with one or more embodiments of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for fabrication of a pressure sensor module capable of operation at high temperatures. As noted above, pressure sensors are devices configured to measure pressure and have many uses in the industrial, automotive, medical, environmental, aerospace, and military arenas. Existing pressure sensors are typically limited, however, to operation in relatively low temperature environments, for example at less than 250 degrees C. Some applications, such as aerospace and military applications, can present more challenging operating environments in which existing pressure sensors may fail. A pressure sensor configured to operate reliably over extended periods of time at high temperatures (e.g., at temperatures exceeding 800 degrees C.), may be used in challenging application environments such as hypersonic flight, jet engine performance monitoring, space exploration, and industrial process control.

To this end, and in accordance with an embodiment of the present disclosure, a high temperature pressure sensor module is disclosed which is fabricated using materials having compatible thermal expansion properties such as silicon carbide (SiC) and lanthanum/gallium based compositions, which are suitable for use at higher temperatures. In some embodiments, thermal compression bonding is used instead of solder, and platinum or gold is used for chip-to-chip bonding and signal routing, due to the ability of platinum to withstand higher temperatures.

In accordance with an embodiment, a high temperature pressure sensor module includes a carrier comprising a chemical compound including lanthanum and gallium, a signal conditioning circuit die disposed on the carrier, and a pressure transducer die disposed on the carrier, adjacent to the signal conditioning circuit die.

The pressure transducer die comprises a membrane comprising a chemical compound including lanthanum and gallium; a plurality of metal contacts disposed on a first side of the membrane; a first cavity etched into a second side of the membrane and configured as a first side of a first piezoelectric pressure transducer; a second cavity etched into the second side of the membrane and configured as a first side of a second piezoelectric pressure transducer; and a carrier comprising the chemical compound including lanthanum and gallium, the carrier bonded to the second side of the membrane such that the carrier forms a second side to the first piezoelectric pressure transducer and a second side to the second piezoelectric pressure transducer.

The signal conditioning circuit die comprises a substrate layer, the substrate layer including: an n-type SiC wafer, and an epitaxial SiC layer disposed on the wafer; an aluminum layer implanted into the epitaxial SiC layer; one or more transistors disposed on the aluminum layer, the transistors including: an n-type channel region comprising phosphorous or nitrogen, an n-type source region, comprising phosphorous or nitrogen, implanted on a first end of the channel, an n-type drain region, comprising phosphorous or nitrogen, implanted on a second end of the channel, a p-type gate wrapped around the channel region between the first end and the second end, the gate comprising aluminum, and contact pads disposed on the source region, the drain region, and the gate.

It will be appreciated that the techniques described herein may provide improved pressure sensor performance at high temperatures, compared to existing pressure sensors. Numerous embodiments and applications will be apparent in light of this disclosure.

### Architecture

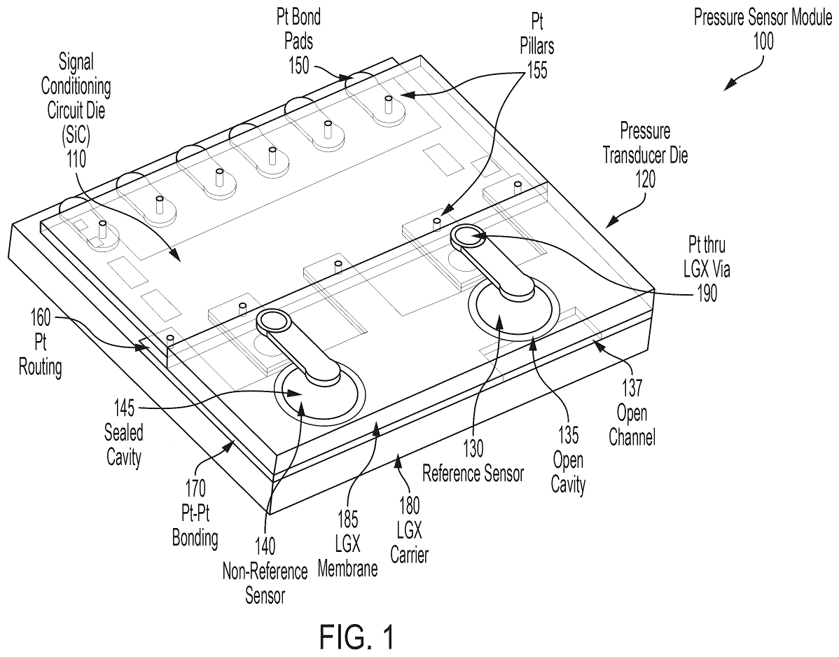

FIG. 1 illustrates a pressure sensor module 100, configured in accordance with certain embodiments of the present disclosure. The pressure sensor module 100 is shown to include a signal conditioning circuit die 110 and a pressure transducer die 120, both disposed, for example adjacent to each other, on a carrier 180. In some embodiments, the pressure transducer die 120 and the carrier 180 are a piezoelectric chemical compound comprising lanthanum (La), gallium (Ga), and silicon (Si). In some embodiments, other elements or compounds may be incorporated, such as, for example, niobium (Nb), tantalum (Ta), calcium (Ca) or aluminum (Al), to name a few. As such, the abbreviation LGX will be used herein to designate the chemical composition of the pressure transducer die 120 and the carrier 180.

In some further embodiments, still other variations are possible. For example, the carrier 180 may comprise any of the following compositions: La₃Ga₅SiO₁₄, Ca₃NbGa₃Si₂O₁₄, La₃Ga₅₋ₓAlₓSiO₁₄, Ca₃Nb(Ga₁₋ₓAlₓ)₃Si₂O₁₄, La₃Ga_{5.5}Nb_{0.5}O₁₄, La₃Nb_{0.5}Ga_{5.3}Al_{0.2}O₁₄, La₃Ga_{5.5}Ta_{0.5}O₁₄, or La₃Ta_{0.5}Ga_{5.5-x}AlₓO₁₄. Chemical compositions described herein may include all stoichiometric variants of those compositions.

The pressure transducer die 120 comprises an LGX membrane 185. In some embodiments, an alternative membrane material may comprise rare-earth calcium oxyborates including GdCOB and YCOB. A first cavity 135 and a second cavity 145 are etched into the bottom side of the membrane (e.g., the side facing the carrier 180). The first cavity 135 is an open cavity which is coupled to an open channel 137 to provide exposure to the ambient environment. The open cavity 135 is employed as a reference pressure sensor 130. The second cavity 145 is a sealed cavity (e.g., after bonding to the LGX carrier 180 via a platinum (Pt) bonding layer 170) and is employed as a non-reference pressure sensor 140.

In some embodiments, the pressure sensors 130 and 140 function as high sensitivity, high bandwidth LGX piezoelectric transducers. Signals generated by the sensors 130 and 140 are provided to the signal conditioning circuit die 110 through Pt vias 190, Pt routing 160, Pt bond pads 150, and Pt pillars 155.

Structural detail and methods of fabrication for the pressure transducer die 120 are described in greater detail below.

The signal conditioning circuit die 110 is configured to amplify the signals provided from the pressure sensors 130 and 140 so that they are suitable for further application specific processing. The signal conditioning circuit die 110 comprises a silicon carbide (SiC) base layer which is thermally compatible with the LGX carrier 180 upon which it is disposed. Thermal compatibility is achieved, for example, by the use of materials having a similar thermal coefficient of expansion.

In some embodiments, the signal conditioning circuit die 110 and pressure transducer die 120 may be implemented as flip-chips to provide flush integration with the carrier 180.

Structural detail and methods of fabrication for the signal conditioning circuit die 110 are described in greater detail below.

The resulting pressure sensor module 100 may provide stable operation for greater than one hour at 800 degrees C. In some embodiments, the pressure sensor module 100 may have a total surface area of less than 30 square millimeters. In some embodiments, platinum pillars 155 are used to provide stress relaxation for any remaining thermal mismatch between the dies 110, 120 and the carrier 180. The platinum pillars 155 may be formed using thermal compression bonding, instead of solder which melts at higher temperatures. In some embodiments, the pillars may be made of gold.

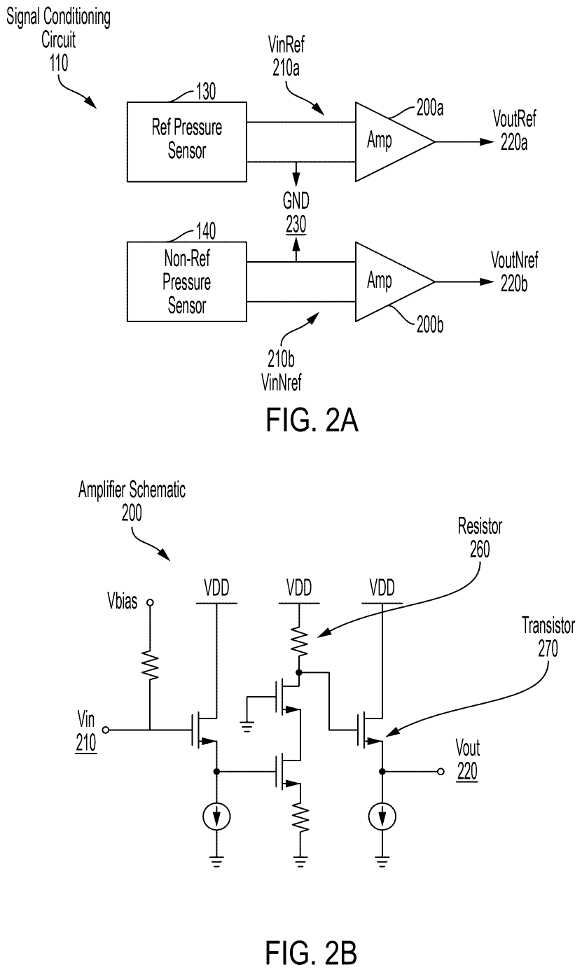

FIG. 2A is a block diagram of the signal conditioning circuit 110 of FIG. 1, configured in accordance with certain embodiments of the present disclosure. The signal conditioning circuit 110 is shown to include the reference pressure sensor/transducer 130 and the non-reference pressure sensor/transducer 140. In some embodiments, the reference sensor 130 is configured to measure ambient pressure which may then be subtracted from the pressure measurement obtained by the non-reference sensor 140 to obtain a corrected pressure measurement.

Each sensor 130, 140 is coupled to an amplifier 200 that is configured to amplify the signal from the pressure sensor to a more useful level. For example, amplifier 200a is configured to amplify the signal VinRef 210a from the reference pressure sensor 130 to an output signal VoutRef 220a. Similarly, amplifier 200b is configured to amplify the signal VinNRef 210b from the non-reference pressure sensor 140 to an output signal VoutNRef 220b. Amplifiers 200a and 200b share a common ground 230.

FIG. 2B is a schematic circuit diagram of the amplifiers 200 of FIG. 2A, configured in accordance with certain embodiments of the present disclosure. Amplifiers 200 (e.g., 200a and 200b) are shown as a circuit that includes transistors 270 (e.g., junction field effect transistors (JFETs)) along with passive components such as resistors 260. The amplifier circuit is configured to amplify the input signal Vin 210 to generate the output signal Vout 220. The circuit schematic shown is one example of an amplifier circuit. Other suitable amplifier circuit designs utilizing transistor may be employed.

The JFETs are implemented as SiC structures with lateral, all-implantation-formed, gate-all-around SiC architecture, as described in detail below. Passive components, such as the resistors 260 are also implemented as monolithically integrated SiC components. In some embodiments, diodes (or JFETs) may be integrated into the circuit as capacitive elements that provide circuit stability.

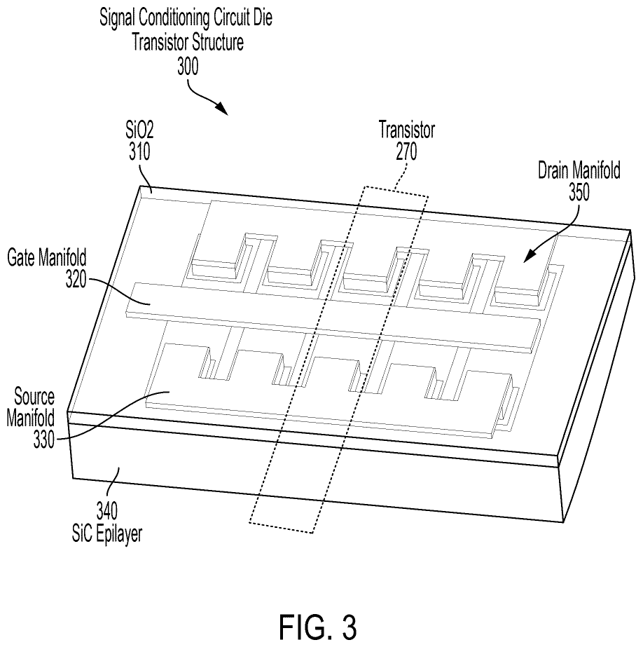

FIG. 3 is a perspective view of the structure 300 of an example multi-channel transistor of FIG. 2B, configured in accordance with certain embodiments of the present disclosure. The transistors in this example are n-type JFETs that include a source region, a drain region, a gate region, and a channel region. In some embodiments, the transistors can include one or more channels. The structure 300 is shown to include a manifold of transistor source regions 330, a manifold of transistor gate regions 320, and a manifold of transistor drain regions 350. The three manifolds are disposed on a SiC layer 340 which may be formed by epitaxial deposition The SiC layer is an unintentionally doped (UID) layer. The three manifolds are embedded within a silicon dioxide (SiO₂) layer 310.

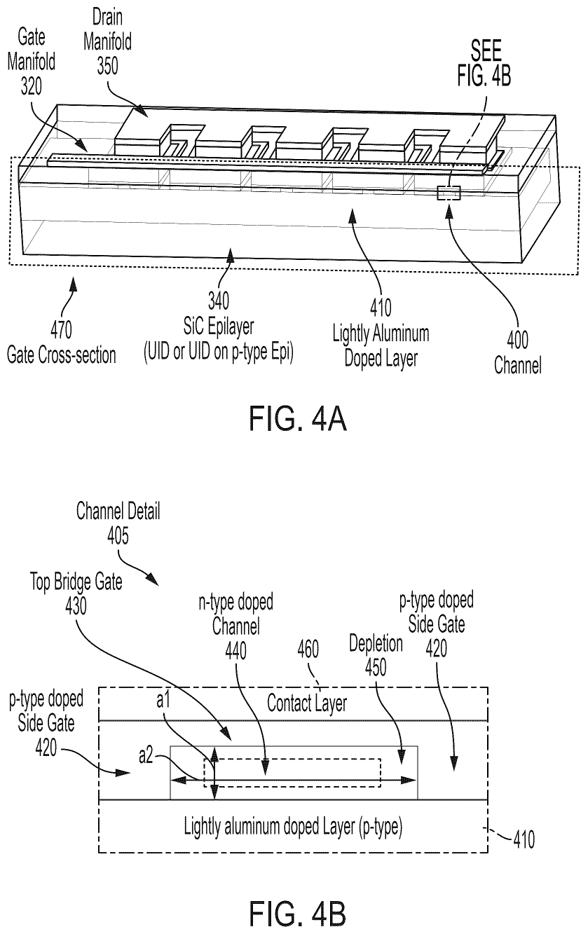

FIG. 4A is a cross-sectional and perspective view of the gate and channel of FIG. 3, configured in accordance with certain embodiments of the present disclosure. The cross-sectional view 470 of the gate manifold 320 is shown to include a bottom SiC UID epitaxial (EPI) layer 340, upon which a lightly aluminum doped (e.g., p-type doped) layer 410 is disposed. A channel region 400 is disposed on layer 410.

FIG. 4B is a detailed cross-sectional view 405 of one channel of the multi-channel transistor of FIG. 4A, configured in accordance with certain embodiments of the present disclosure. This channel region 400 is shown to include an n-type doped channel 440 of dimensions a1 by a2 surrounded by a depletion zone 450. In some embodiments, a1 and a2 may be in the range of 0.5 micrometers to 3 micrometers. The channel region is surrounded by a gate all-around (GAA) region which includes p-type doped side gates 420 and top bridge gate 430. A metallic contact layer 460 is shown to be disposed on the GAA region 420, 430.

### Fabrication Methodology

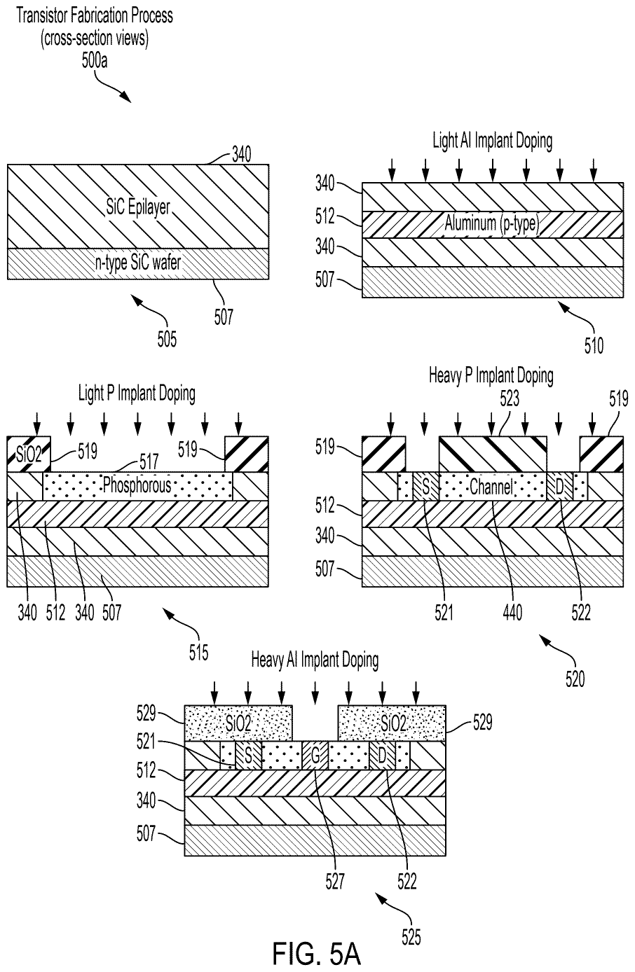

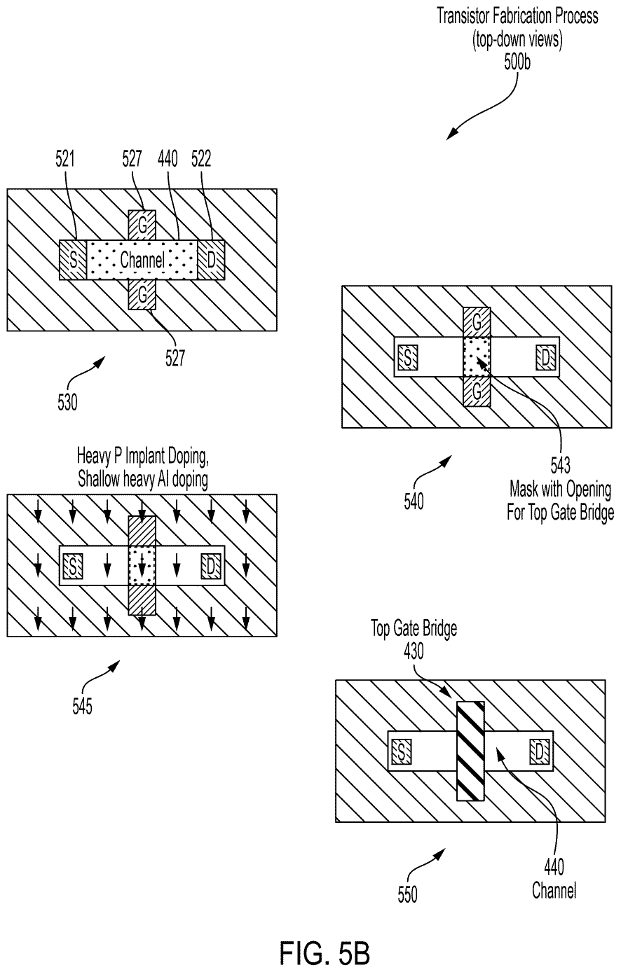

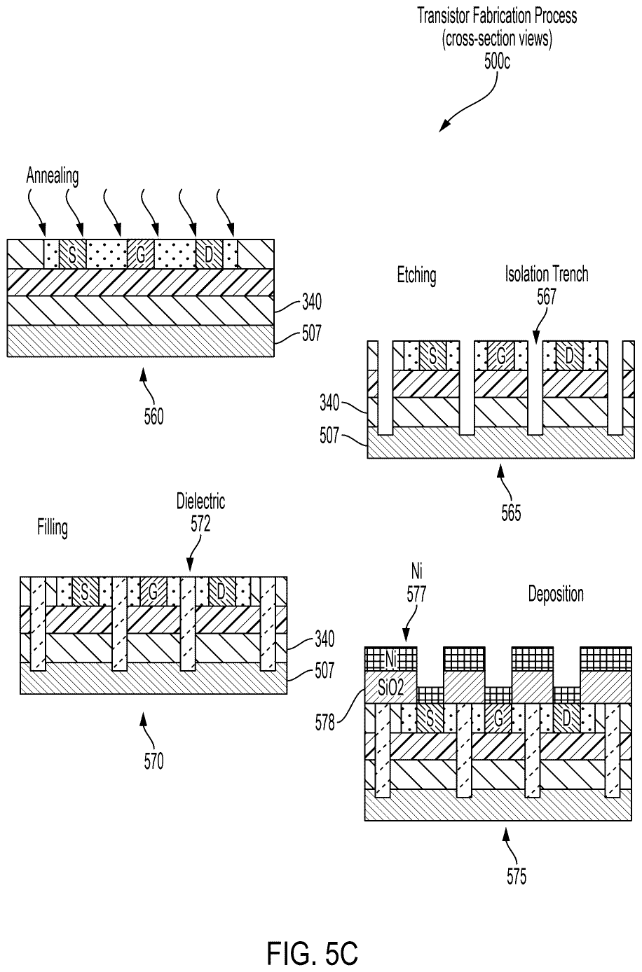

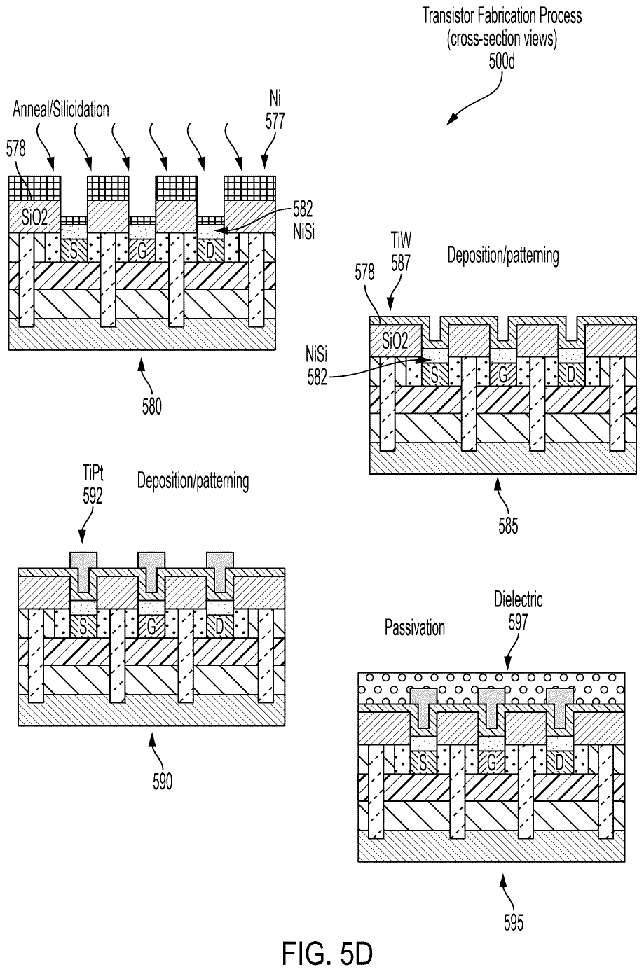

FIGS. 5A-5D illustrate cross-sectional and top-down views that collectively illustrate an example process for forming the transistors (e.g., transistor 270) of FIGS. 2B and 3, in accordance with an embodiment of the present disclosure. Each figure shows an example structure that results from the process flow up to that point in time, so the depicted structure evolves as the process flow continues, culminating in the structure 595 shown in FIG. 5D.

FIG. 5A illustrates cross-sectional views 500a associated with steps of the transistor fabrication process. The first view 505 depicts an SiC EPI layer 340 disposed on an SiC wafer 507. In some embodiments, the SiC EPI layer 340 is an unintentionally doped (UID) layer or a UID layer disposed on a p-type epitaxial layer.

The next view 510 depicts a lightly doped aluminum (Al) p-type layer 512 within the SiC UID EPI 340. According to some embodiments, an implant doping process is used to form the lightly doped Al 512 at a temperature on the order of 600 degrees C. According to some embodiments, the implant doping process (in this and subsequent steps) is performed at a temperature on the order of 600 degrees C.

View 515 depicts the application of a mask (e.g., SiO₂ 519) followed by lightly doped phosphorous implanting to form an n-type phosphorous region 517 as a top layer in the SiC UID EPI 340 between the masks 519. In some embodiments, masks are patterned and applied using lithographic techniques.

View 520 depicts the application of additional SiO₂ mask material 523 followed by heavily doped phosphorous implanting to form the n-type source region 521 and drain region 522. The remaining (masked off) lightly phosphorous doped region becomes the channel 440. The masking material 519, 523 is then removed, for example using chemical-mechanical polishing.

In some embodiments, the n-type channel region, n-type source region, and n-type drain region may comprise nitrogen instead of phosphorous.

View 525 depicts the application of new SiO₂ mask material 529 followed by heavily doped aluminum implanting to form the p-type gate region 527 (e.g., side gates 420). The masking material 529 is then removed.

FIG. 5B illustrates top-down views 500b associated with subsequent steps of the transistor fabrication process. The first view 530 depicts (e.g., from above) the source region 521, the drain region 522, the channel region 440 coupling the source and drain regions, and portions of the gate region 527 on either side of the channel 440.

The next view 540 depicts the application of new SiO₂ mask material with an opening 543 for the top gate bridge.

View 545 depicts heavily doped phosphorous implanting followed by a shallower heavily doped aluminum implanting to form the p-type top gate region (e.g., top bridge gate 430).

View 550 depicts the resulting top gate bridge 430, channel 440, source 521, and drain 522.

FIG. 5C illustrates cross-sectional views 500c associated with subsequent steps of the transistor fabrication process. The first view 560 depicts an annealing process. In some embodiments, the annealing process may be performed at a temperature exceeding 1650 degrees C. for one to two hours in an argon gas environment.

The next view 565 depicts the etching of isolation trenches 567.

View 570 depicts filling of the isolation trenches 567 with a dielectric material 572.

View 575 depicts the application of another mask (e.g., SiO₂ 578) to cover regions other than the source, drain, and gate, followed by the deposition of nickel 577. In some embodiments, the nickel deposition is on the order of 100 nanometers thickness. In some embodiments, materials other than nickel may be used, including, for example: titanium, tantalum, palladium, aluminum, molybdenum, niobium, nickel, chromium, cobalt/silicon/cobalt, tantalum/carbon, nickel/chromium, nickel/silicon, tantalum carbide/tungsten, titanium carbide, titanium/tantalum silicide/platinum, aluminum/silicon, aluminum/titanium, molybdenum/aluminum, titanium nitride, or any combination thereof.

FIG. 5D illustrates cross-sectional views 500d associated with subsequent steps of the transistor fabrication process. The first view 580 depicts an annealing/silicidation process. In some embodiments, the annealing/silicidation process may be performed at a temperature on the order of 1000 degrees C. for two minutes in an argon gas environment to produce NiSi 582. In some embodiments, metal silicides other than NiSi may be used. In some embodiments, the metal silicide may be tantalum silicide.

The next view 585 shows the removal of any remaining Nickel 577 followed by deposition/patterning of a layer of titanium tungsten (TiW) 587 formed over the NiSi 582 and SiO2 578. In some embodiments, materials other than TiW may be used, including, for example: platinum, gold, tungsten, palladium, rhodium or any combination thereof.

View 590 depicts deposition/patterning of titanium platinum (TiPt) 592 over the TiW 587 layer in the area over the source, drain, and gate regions to form contact pads. TiPt may be used to cover the TiW material since TiW oxidizes over time while TiPt is inert.

View 595 depicts the formation of a passivation layer 597 comprising a combination of SiO₂ and SiN 597 over the region of the transistor. In some embodiments, the passivation layer may comprise SiON, SiN, AlN, Al2O3, or any combination thereof.

While the transistors described in the example above are n-type JFETs, it will be appreciated that p-type JFETs may also be fabricated in a similar manner in which, for example, aluminum and phosphorous are interchanged for the doping processes.

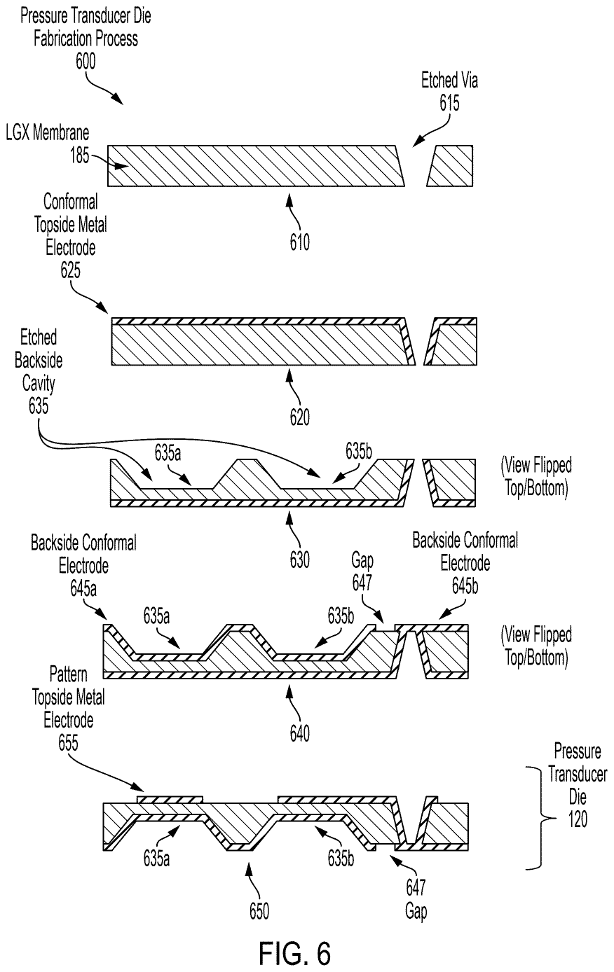

FIG. 6 illustrates cross-sectional views that collectively illustrate an example process for forming the pressure transducer die 120 of FIG. 1, in accordance with certain embodiments of the present disclosure. The first view 610 depicts a via 615 etched into the LGX membrane 185.

The next view 620 depicts the application of a conformal metal electrode 625 to the topside of the LGX membrane 185.

View 630 shows the LGX membrane 185 flipped (e.g., top to bottom) to depict etching of cavities 635 (635a and 635b) in the backside of the membrane (e.g., the side that will be adjoined to the surface of the carrier 180). The diameter of the cavities and the thickness of the membranes may be selected based on required bandwidths of the pressure sensors. For example, greater bandwidths may be achieved with smaller diameters.

View 640 depicts the application of a conformal metal electrode 645 to the backside of the LGX membrane 185. The electrode 645 is then patterned to leave a gap 647 to separate the electrode 645 into two parts 645a and 645b such that 645b is coupled to the topside electrode 625 while 645a is isolated from the topside electrode 625.

View 650 shows the LGX membrane 185 flipped backed to the original orientation. View 650 depicts patterning of the topside electrode 625 to form a patterned topside metal electrode 655 having one portion located over cavity 635a which is isolated from the other portion located over cavity 635b. View 650 thus provides a cross-sectional view of the resulting pressure transducer die 120.

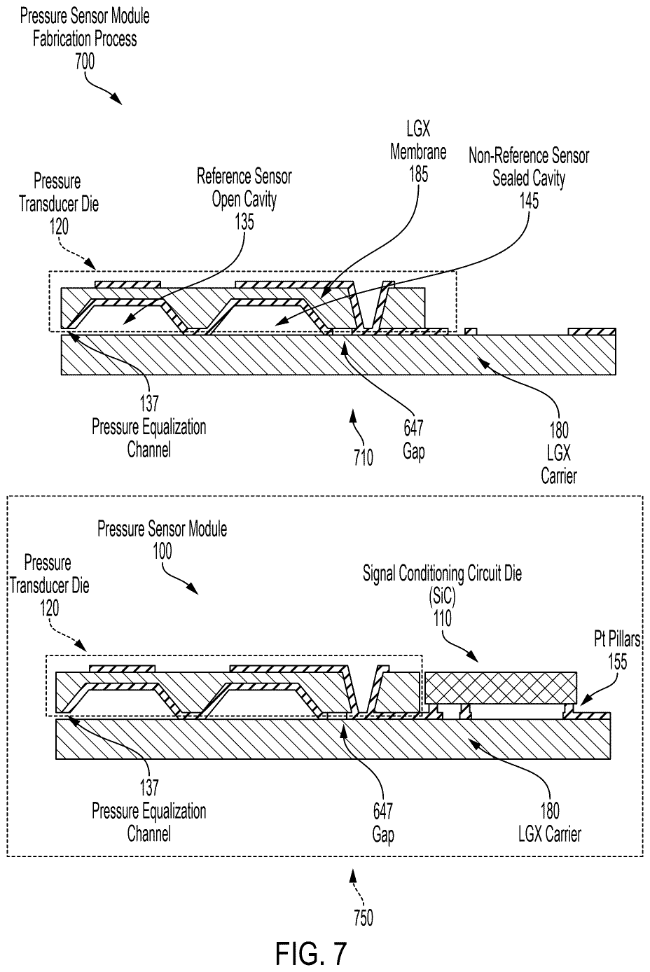

FIG. 7 illustrates cross-sectional views that collectively illustrate an example process for forming the pressure sensor module 100 of FIG. 1, in accordance with certain embodiments of the present disclosure. The first view 710 depicts the pressure transducer die 120 disposed over the LGX carrier 180. A gap is shown between the pressure transducer die 120 and the LGX carrier 180 to form the pressure equalization channel 137 for the open cavity 135 of the reference sensor 130. In contrast, the LGX membrane 185 and the LGX carrier 180 form a sealed cavity 145 for the non-reference sensor 140.

View 750 depicts the SiC signal conditioning circuit die 110 disposed on the LGX carrier 180 to form the resulting pressure sensor module 100. Platinum pillars 155 are shown to provide electrical coupling between the circuit components, the sensors, and the bond pads 150. The platinum pillars 155 may be formed using thermal compression bonding, instead of solder which melts at higher temperatures. In some embodiments, the pillars 155 and other signal routing metal may comprise gold or a combination of platinum and gold.

### Methodology

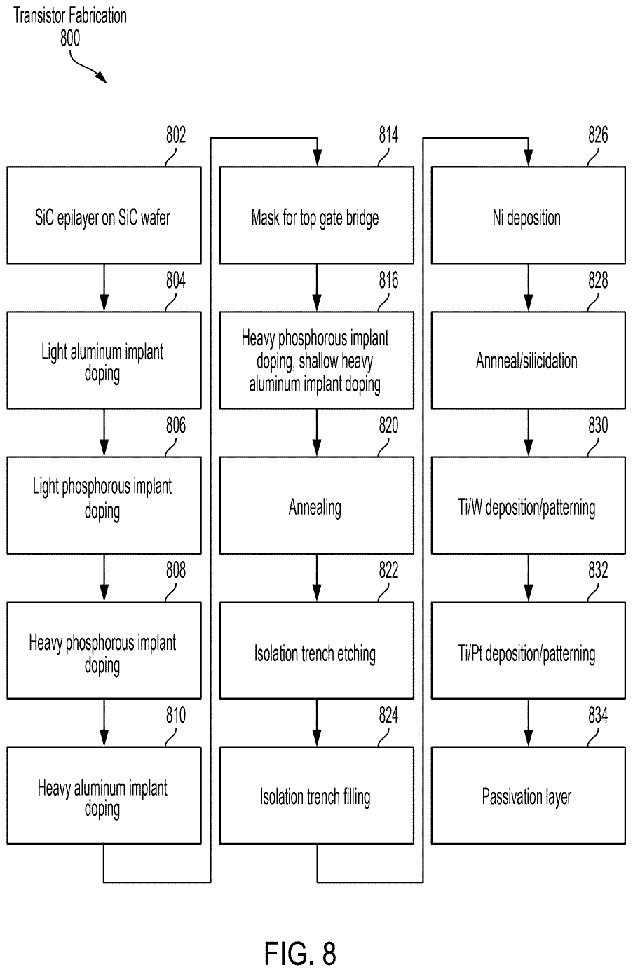

FIG. 8 is a flow chart of a method 800 for forming an integrated circuit structure including a transistor, in accordance with one or more embodiments of the present disclosure. Various operations of method 800 may be illustrated in FIGS. 5A-5D. However, the correlation of the various operations of method 800 to the specific components illustrated in the aforementioned figures is not intended to imply any structural and/or use limitations. Rather, the aforementioned figures provide one example embodiment of method 800. Other operations may be performed before, during, or after any of the operations of method 800. For example, method 800 does not explicitly describe all processes that are performed to form common transistor structures. Some of the operations of method 800 may be performed in a different order than the illustrated order.

Method 800 begins at operation 802, by disposing an SiC UID EPI layer 340 on an SiC wafer 507. In some embodiments, the SiC wafer 507 comprises a p-type EPI layer disposed on an n-type SiC wafer.

Method 800 continues with operation 804, by performing light aluminum implant doping to form a p-type layer 512 within the SiC UID EPI 340. According to some embodiments, the implant doping process (in this and subsequent operations) is performed at a temperature on the order of 600 degrees C.

Method 800 continues with operation 806, by applying a mask (e.g., SiO₂ 519) and then performing light phosphorous implant doping to form an n-type phosphorous region 517 as a top layer in the SiC UID EPI 340 between the masks 519.

Method 800 continues with operation 808, by applying additional SiO₂ mask material 523 followed by performing heavy phosphorous implant doping to form the n-type source region 521 and drain region 522. The remaining (masked off) lightly phosphorous doped region becomes the channel 440. The masking material 519, 523 is then removed.

Method 800 continues with operation 810, by applying new SiO₂ mask material 529 followed by performing heavy aluminum implant doping to form the p-type gate region 527 (e.g., side gates 420). The masking material 529 is then removed.

Method 800 continues with operation 814, by applying new SiO₂ mask material with an opening 543 for the top gate bridge.

Method 800 continues with operation 816, by performing heavy phosphorous implant doping followed by a shallower heavy aluminum implant doping to form the p-type top gate region (e.g., top bridge gate 430).

Method 800 continues with operation 820, by annealing the structure. In some embodiments, the annealing process may be performed at a temperature exceeding 1650 degrees C. for one to two hours in an argon gas environment.

Method 800 continues with operation 822, by etching of isolation trenches 567.

Method 800 continues with operation 824, by filling the isolation trenches 567 with a dielectric material 572.

Method 800 continues with operation 826, by applying another mask (e.g., SiO₂ 578) to cover regions other than the source, drain, and gate, and then depositing nickel 577. In some embodiments, the nickel deposition is on the order of 100 nanometers thickness.

Method 800 continues with operation 828, by performing an annealing/silicidation process. In some embodiments, the annealing/silicidation process may be performed at a temperature on the order of 1000 degrees C. for two minutes in an argon gas environment to produce NiSi 582.

Method 800 continues with operation 830, by removing any remaining Nickel 577 and then a layer of titanium tungsten (TiW) 587 over the NiSi 582 and SiO2 578, for example by performing deposition/patterning.

Method 800 continues with operation 832, by forming titanium platinum (TiPt) 592 over the TiW 587 layer in the area over the source, drain, and gate regions, for example by performing deposition/patterning.

Method 800 continues with operation 834, by forming a passivation layer 597 comprising a combination of SiO₂ and SiN 597 over the region of the transistor. In some embodiments, the passivation layer may comprise SiON or SiN.

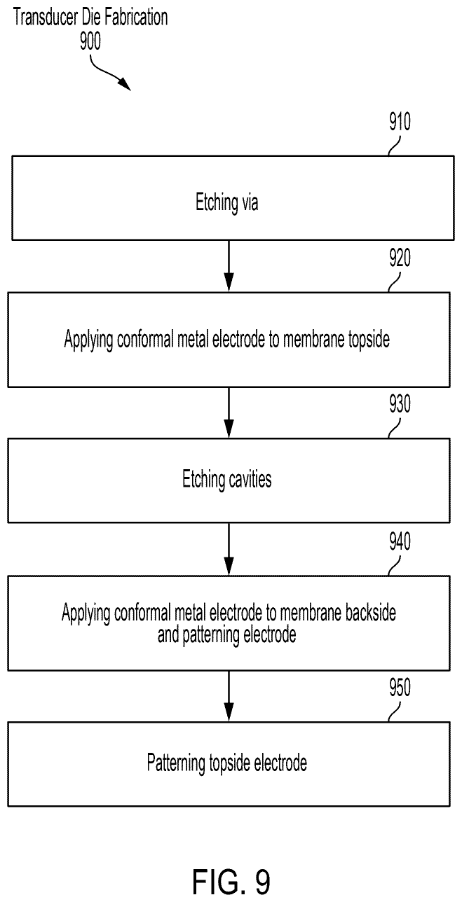

FIG. 9 is a flow chart of a method 900 of forming a transducer die, in accordance with one or more embodiments of the present disclosure. Various operations of method 900 may be illustrated in FIG. 6. However, the correlation of the various operations of method 900 to the specific components illustrated in the aforementioned figure is not intended to imply any structural and/or use limitations. Rather, the aforementioned figure provides one example embodiment of method 900. Other operations may be performed before, during, or after any of the operations of method 900. Some of the operations of method 800 may be performed in a different order than the illustrated order.

Method 900 begins at operation 910, by etching a via 615 into the LGX membrane 185.

Method 900 continues with operation 920, by applying a conformal metal electrode 625 to the topside of the LGX membrane 185.

Method 900 continues with operation 930, by etching of two cavities (635a and 635b) in the backside of the membrane (e.g., the side that will adjoin to the surface of the carrier 180).

Method 900 continues with operation 940, by applying a conformal metal electrode 645 to the backside of the LGX membrane 185. The electrode 645 is then patterned to leave a gap 647 to separate the electrode 645 into two parts 645a and 645b such that 645b is coupled to the topside electrode 625 while 645a is isolated from the topside electrode 625.

Method 900 continues with operation 950, by patterning the topside electrode 625 to form a patterned topside metal electrode 655 having one portion located over cavity 635a which is isolated from the other portion located over cavity 635b.

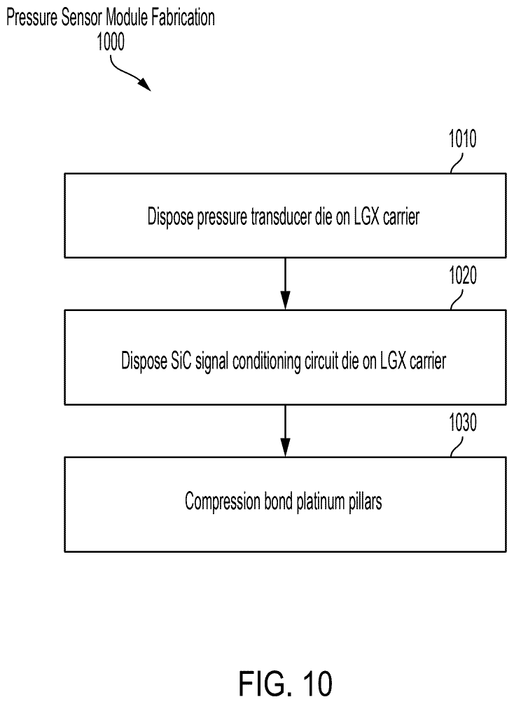

FIG. 10 is a flow chart of a method 1000 of forming a pressure sensor module, in accordance with one or more embodiments of the present disclosure. Various operations of method 1000 may be illustrated in FIG. 7. However, the correlation of the various operations of method 1000 to the specific components illustrated in the aforementioned figure is not intended to imply any structural and/or use limitations. Rather, the aforementioned figure provides one example embodiment of method 1000. Other operations may be performed before, during, or after any of the operations of method 1000. Some of the operations of method 1000 may be performed in a different order than the illustrated order.

Method 1000 begins at operation 1010, by disposing the pressure transducer die 120 over the LGX carrier 180 such that a gap is created between the pressure transducer die 120 and the LGX carrier 180 to form the pressure equalization channel 137 for the open cavity 135 of the reference sensor 130.

Method 1000 continues with operation 1020, by disposing the SiC signal conditioning circuit die 110 on the LGX carrier 180.

Method 1000 continues with operation 1040, by compression bonding platinum pillars to support the SiC signal conditioning circuit die 110 on the LGX carrier 180.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.
Example 1 is a piezoelectric pressure transducer die comprising: a membrane; a plurality of metal contacts disposed on a first side of the membrane; a first cavity etched into a second side of the membrane and configured as a first side of a first piezoelectric pressure transducer; a second cavity etched into the second side of the membrane and configured as a first side of a second piezoelectric pressure transducer; and a carrier comprising the chemical compound including lanthanum and gallium, the carrier bonded to the second side of the membrane such that the carrier forms a second side to the first piezoelectric pressure transducer and a second side to the second piezoelectric pressure transducer.
Example 2 includes the die of Example 1, wherein the membrane includes lanthanum and gallium and one or more of silicon, niobium, tantalum, calcium, and aluminum, or the membrane includes rare-earth calcium oxyborates.
Example 3 includes the die of Examples 1 or 2, wherein the chemical compound further includes one or more of silicon, niobium, tantalum, calcium, or aluminum.
Example 4 includes the die of any of Examples 1-3, wherein the first piezoelectric pressure transducer is a reference sensor configured to measure pressure including ambient pressure.
Example 5 includes the die of Example 4, wherein the first piezoelectric pressure transducer is coupled to a pressure equalization channel configured to provide an opening to the first cavity.
Example 6 includes the die of any of Examples 1-5, wherein the second cavity is a sealed cavity, and the second piezoelectric pressure transducer is a non-reference sensor configured to measure pressure other than ambient pressure.
Example 7 includes the die of any of Examples 1-6, comprising pillars configured to provide routing of signals from the first piezoelectric pressure transducer and the second piezoelectric pressure transducer to a signal conditioning circuit, the pillars including platinum or gold.
Example 8 is a pressure sensor module comprising: a carrier comprising a chemical compound including lanthanum and gallium; a signal conditioning circuit die disposed on the carrier, the signal conditioning die comprising a substrate layer including: an n-type silicon carbide (SiC) wafer, an epitaxial SiC layer disposed on the wafer, and one or more transistors disposed on the substrate layer; and a pressure transducer die disposed on the carrier, adjacent to the signal conditioning circuit die, the pressure transducer die comprising: a membrane, a plurality of metal contacts disposed on a first side of the membrane, a first cavity etched into a second side of the membrane and configured as a first side of a first piezoelectric pressure transducer, and a second cavity etched into the second side of the membrane and configured as a first side of a second piezoelectric pressure transducer, wherein the carrier is bonded to the second side of the membrane such that the carrier forms a second side to the first piezoelectric pressure transducer and a second side to the second piezoelectric pressure transducer.
Example 9 includes the module of Example 8, wherein the chemical compound further includes one or more of silicon, niobium, tantalum, calcium, or aluminum.
Example 10 includes the module of Examples 8 or 9, wherein the membrane includes lanthanum and gallium and one or more of silicon, niobium, tantalum, calcium, and aluminum, or the includes rare-earth calcium oxyborates.
Example 11 includes the module of any of Examples 8-10, wherein the first piezoelectric pressure transducer is a reference sensor configured to measure pressure including ambient pressure and the first piezoelectric pressure transducer is coupled to a pressure equalization channel configured to provide an opening to the first cavity.
Example 12 includes the module of any of Examples 8-11, wherein the second cavity is a sealed cavity, and the second piezoelectric pressure transducer is a non-reference sensor configured to measure pressure other than ambient pressure.
Example 13 includes the module of any of Examples 8-12, wherein the one or more transistors comprise: an n-type channel region comprising phosphorous or nitrogen, an n-type source region, comprising phosphorous or nitrogen, implanted on a first end of the channel, an n-type drain region, comprising phosphorous or nitrogen, implanted on a second end of the channel, a p-type gate wrapped around the channel region between the first end and the second end, the gate comprising aluminum, and contact pads disposed on the source region, the drain region, and the gate, wherein the phosphorus of the channel region is more lightly doped than the phosphorous of the source and drain regions, and the contact pads are a metal silicide coated with titanium tungsten and the titanium tungsten is coated at least in part with titanium platinum.
Example 14 is a signal conditioning circuit die comprising: a substrate layer, the substrate layer including: an n-type silicon carbide (SiC) wafer, and an epitaxial SiC layer disposed on the wafer; an aluminum layer implanted into the epitaxial SiC layer; one or more transistors disposed on the aluminum layer, the transistors including: an n-type channel region comprising phosphorous or nitrogen, an n-type source region, comprising phosphorous or nitrogen, implanted on a first end of the channel, an n-type drain region, comprising phosphorous or nitrogen, implanted on a second end of the channel, a p-type gate wrapped around the channel region between the first end and the second end, the gate comprising aluminum, and contact pads disposed on the source region, the drain region, and the gate.
Example 15 includes the die of Example 14, wherein the epitaxial SiC layer is an unintentionally doped (UID) layer or a UID layer disposed on a p-type epitaxial layer.
Example 16 includes the die of Examples 14 or 15, wherein the phosphorus or nitrogen of the channel region is more lightly doped than the phosphorous of the source and drain regions.
Example 17 includes the die of any of Examples 14-16, wherein the contact pads are a metal silicide coated with titanium tungsten.
Example 18 includes the die of Example 17, wherein the titanium tungsten is coated at least in part with titanium platinum.
Example 19 includes the die of Example 18, comprising a passivation layer disposed on the titanium tungsten and the titanium platinum, the passivation layer comprising a dielectric.
Example 20 includes the die of any of Examples 14-19, comprising isolation trenches between the source region and the gate region and between the gate region and the drain region, the isolation trenches filled with a dielectric material.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A piezoelectric pressure transducer die comprising:
a membrane;
a plurality of metal contacts disposed on a first side of the membrane;
a first cavity etched into a second side of the membrane and configured as a first side of a first piezoelectric pressure transducer;
a second cavity etched into the second side of the membrane and configured as a first side of a second piezoelectric pressure transducer; and
a carrier comprising the chemical compound including lanthanum and gallium, the carrier bonded to the second side of the membrane such that the carrier forms a second side to the first piezoelectric pressure transducer and a second side to the second piezoelectric pressure transducer.

2. The die of claim 1, wherein the membrane includes lanthanum and gallium and one or more of silicon, niobium, tantalum, calcium, and aluminum, or the membrane includes rare-earth calcium oxyborates.

3. The die of claim 1, wherein the chemical compound further includes one or more of silicon, niobium, tantalum, calcium, or aluminum.

4. The die of claim 1, wherein the first piezoelectric pressure transducer is a reference sensor configured to measure pressure including ambient pressure.

5. The die of claim 4, wherein the first piezoelectric pressure transducer is coupled to a pressure equalization channel configured to provide an opening to the first cavity.

6. The die of claim 1, wherein the second cavity is a sealed cavity, and the second piezoelectric pressure transducer is a non-reference sensor configured to measure pressure other than ambient pressure.

7. The die of claim 1, comprising pillars configured to provide routing of signals from the first piezoelectric pressure transducer and the second piezoelectric pressure transducer to a signal conditioning circuit, the pillars including platinum or gold.

8. A pressure sensor module comprising:
a carrier comprising a chemical compound including lanthanum and gallium;
a signal conditioning circuit die disposed on the carrier, the signal conditioning die comprising a substrate layer including:
an n-type silicon carbide (SiC) wafer,
an epitaxial SiC layer disposed on the wafer, and
one or more transistors disposed on the substrate layer; and
a pressure transducer die disposed on the carrier, adjacent to the signal conditioning circuit die, the pressure transducer die comprising:
a membrane,
a plurality of metal contacts disposed on a first side of the membrane,
a first cavity etched into a second side of the membrane and configured as a first side of a first piezoelectric pressure transducer, and
a second cavity etched into the second side of the membrane and configured as a first side of a second piezoelectric pressure transducer, wherein
the carrier is bonded to the second side of the membrane such that the carrier forms a second side to the first piezoelectric pressure transducer and a second side to the second piezoelectric pressure transducer.

9. The module of claim 8, wherein the chemical compound further includes one or more of silicon, niobium, tantalum, calcium, or aluminum.

10. The module of claim 8, wherein the membrane includes lanthanum and gallium and one or more of silicon, niobium, tantalum, calcium, and aluminum, or the includes rare-earth calcium oxyborates.

11. The module of claim 8, wherein the first piezoelectric pressure transducer is a reference sensor configured to measure pressure including ambient pressure and the first piezoelectric pressure transducer is coupled to a pressure equalization channel configured to provide an opening to the first cavity.

12. The module of claim 8, wherein the second cavity is a sealed cavity, and the second piezoelectric pressure transducer is a non-reference sensor configured to measure pressure other than ambient pressure.

13. The module of claim 8, wherein the one or more transistors comprise:
an n-type channel region comprising phosphorous or nitrogen,
an n-type source region, comprising phosphorous or nitrogen, implanted on a first end of the channel,
an n-type drain region, comprising phosphorous or nitrogen, implanted on a second end of the channel,
a p-type gate wrapped around the channel region between the first end and the second end, the gate comprising aluminum, and
contact pads disposed on the source region, the drain region, and the gate, wherein the phosphorus of the channel region is more lightly doped than the phosphorous of the source and drain regions, and the contact pads are a metal silicide coated with titanium tungsten and the titanium tungsten is coated at least in part with titanium platinum.

14. A signal conditioning circuit die comprising:
a substrate layer, the substrate layer including:
an n-type silicon carbide (SiC) wafer, and
an epitaxial SiC layer disposed on the wafer;
an aluminum layer implanted into the epitaxial SiC layer;
one or more transistors disposed on the aluminum layer, the transistors including:
an n-type channel region comprising phosphorous or nitrogen,
an n-type source region, comprising phosphorous or nitrogen, implanted on a first end of the channel,
an n-type drain region, comprising phosphorous or nitrogen, implanted on a second end of the channel,
a p-type gate wrapped around the channel region between the first end and the second end, the gate comprising aluminum, and
contact pads disposed on the source region, the drain region, and the gate.

15. The die of claim 14, wherein the epitaxial SiC layer is an unintentionally doped (UID) layer or a UID layer disposed on a p-type epitaxial layer.

16. The die of claim 14, wherein the phosphorus or nitrogen of the channel region is more lightly doped than the phosphorous of the source and drain regions.

17. The die of claim 14, wherein the contact pads are a metal silicide coated with titanium tungsten.

18. The die of claim 17, wherein the titanium tungsten is coated at least in part with titanium platinum.

19. The die of claim 18, comprising a passivation layer disposed on the titanium tungsten and the titanium platinum, the passivation layer comprising a dielectric.

20. The die of claim 14, comprising isolation trenches between the source region and the gate region and between the gate region and the drain region, the isolation trenches filled with a dielectric material.
